(19) United States
(12) Patent Application Publication
(10) Pub. No.: US 2016/0325923 A1
(43) Pub. Date: Nov. 10, 2016

(54) PORTION CAPSULE COMPRISING A PLASTIC FILM PROVIDED WITH A MACHINE-DETECTABLE IDENTIFIER

(71) Applicant: K-FEE SYSTEM GMBH, Bergisch Gladbach (DE)

(72) Inventors: Marc KRÜGER, Bergisch-Gladbach (DE); Günter EMPL, Bergisch Gladbach (DE)

(21) Appl. No.: 15/211,961

(22) Filed: Jul. 15, 2016

Related U.S. Application Data
(62) Division of application No. 14/411,571, filed on Dec. 29, 2014.

(30) Foreign Application Priority Data
Jun. 29, 2012 (DE) 10 2012 105 791.5
Jun. 19, 2013 (DE) 10 2013 211 568.7

(51) Int. Cl. B65D 85/804; A47J 31/44; B65D 65/38

(52) U.S. Cl. CPC B65D 85/8043; B65D 65/38; A47J 31/4492

(57) ABSTRACT

The invention relates to a portion capsule for producing a beverage, comprising a capsule body with a capsule base and a cover. A cavity, which is formed between the capsule base and the cover comprises a beverage substrate and said capsule comprises a machine-detectable identifier, which enables the respective portion capsule to be individualised. The invention also relates to the use of the portion capsule for producing a beverage.

### CROSS-REFERENCE TO RELATED APPLICATIONS

This application claims benefit from and is a divisional of U.S. application Ser. No. 14/411,571, filed Dec. 29, 2014, entitled PORTION CAPSULE COMPRISING A PLASTIC FILM PROVIDED WITH A MACHINE-DETECTABLE IDENTIFICATION, which claims benefit from and is a National Phase Application of Application No. PCT/EP2013/063802, filed Jul. 1, 2013, entitled PORTION CAPSULE COMPRISING A PLASTIC FILM PROVIDED WITH A MACHINE-DETECTABLE IDENTIFICATION, all of which are hereby incorporated by reference in their entirety.

### FIELD

The invention relates to a portion capsule for producing a beverage, comprising a base element which comprises a cavity in which a beverage raw material is provided and which is sealed by a membrane which is secured to the base element. Said base element is provided with an identifier, which enables the respective portion capsule to be individualised. The invention further relates to a method for producing a portion capsule and to the use of the portion capsule for producing a beverage.

### BACKGROUND

Such portion capsules are well known and are offered on the market in a variety of embodiments. They are used to produce coffee, espresso, cappuccino, tea, milk or cocoa beverages as well as other beverages or foods such as soups. To be able to be produced in a machine these capsules must all have the same outer shape, the difference being in the respective manufacturing method. For example, the amount of water and/or the temperature used for the production of a particular beverage can differ. Furthermore, the water of the portion capsule can be conducted continuously or intermittently through the portion capsule. The vending machines used to produce the particular beverage or food must be cleaned at regular intervals. For this purpose, cleaning capsules are available, the outer dimensions of which are identical to the outer dimensions of the portion capsules, and through which water can also stream after it has [sic] been introduced into the machine, which releases the cleaning substance from the capsules and, with the solution, cleans the machine's infusion chamber and downstream pipes. That a user, for example a child or a visually impaired adult, uses the cleaning capsule to produce a beverage and consumes, must be avoided at all costs.

The object of the present invention, therefore, is to provide a portion capsule which is only suitable for a quite specific beverage vending machine, which can be produced at low cost and/or which can avoid the disadvantages identified in connection with the prior art.

### SUMMARY

The object is achieved with a portion capsule for producing a beverage comprising a capsule body with a capsule base and a cover. A cavity, which is formed between the capsule base and the cover comprises a beverage substrate and said capsule comprises a machine-detectable identifier, which enables the respective portion capsule to be individualised. The identifier is provided in a mono-layer or multi-layer plastic film, from which the portion capsule is, at least partially, produced.

The disclosure made in connection with the present invention applies to the other object of the present invention equally and vice versa.

The invention relates to a portion capsule for producing a beverage or food, which comprises a cavity in which a beverage raw material is provided. Such a portion capsule is made, for example, out of plastic, a natural material and/or a biodegradable material and comprises a base element, in particular a shaped, preferably deep-drawn base element or a base element produced by spikes, which is preferably conical or cylindrical in shape, and comprises a base. The beverage raw material, which is, for example, extracted and/or released from a liquid, in particular water, is poured into the cavity of the portion capsule. Preferably, after the beverage raw material has been poured in, the base element is sealed, in particular with a membrane. The membrane is preferably provided opposite the base of the base element. The membrane can be made from the same material as the base element or from a different material and is preferably attached to the base element through sealing or gluing. The membrane can be designed to be impervious to gas and/or liquids or permeable to gas and/or liquids. Furthermore, one or more built-in elements, such as a filter, a liquid distributor, a fleece, a felt material, a protective foil, and/or such like, can be provided. In the event that a felt material and a fleece are provided, they are preferably bonded to one another. The felt material and/or the fleece can be multi-layered, in which case the layers can differ as to the kind of material used and/or the processing of the material used. The membrane and/or the base can be provided with several recesses (holes).

The invention also provides that this portion capsule comprises an identifier, which enables the respective portion capsule to be individualised.

For the purpose of the invention, ‘to be individualised’ means that the particular portion capsule can be assigned to the appropriate group for the production of a beverage or food or for the cleaning of the vending machine. Is it not necessary for the identifier to disclose which particular portion capsule is being referred to, i.e. for it to contain a serial number or batch number or such like, just to allow the assignment of the particular portion capsule to a group of portion capsules, for example beverage and/or food portion capsule, or cleaning capsule. Preferably, the identifier also makes it possible to distinguish between the individual beverages and/or type of food, for example, that a capsule is being referred to with which tea, coffee, a milky drink or such like, or a soup, can be produced.

Preferably, a sensor/detector, fitted to a vending machine, for example a coffee vending machine, detects this identifier and compares it preferably with a stored identifier. Preferably, the vending machine, in particular its pressure pump, which provides the water, can only be put into operation if the detected identifier matches up with the reference identifier of a beverage/food portion capsule. Otherwise, the vending machine cannot be put into operation, because there is a risk that the capsule identified might be a cleaning capsule in which there is a cleaning agent, for example. In this case, the vending machine can, for example, only be put into operation if a specific key combination is previously pressed on the control panel of the vending machine, with which the user verifies that he or she is aware that this capsule is a cleaning capsule. This will ensure that a cleaning capsule is not accidentally used for the production of a beverage.

Alternatively or additionally, the identifier can be used to ensure that the coffee vending machine drives a specific program, i.e. heats the water to a specified temperature, for example, provides the water at a specified pressure, and/or conveys a specified amount of water through the portion capsule.

Alternatively or additionally, the identifier can be used to sort the materials from which the portion capsule is produced during a subsequent disposal and/or recycling process.

According to the invention, the machine-detectable identifier is provided in the plastic film from which the portion capsule is, at least partially, preferably completely, produced. ‘Provided in the plastic film’ means that, when the plastic film is produced, the identifier is integrated into it and, when the plastic film is deformed to produce the corresponding part of the portion capsule, preferably the cover or the capsule body or, in the event that the capsule body and/or the cover is produced through moulding or injection moulding, is already available in the plastic mass. This has the advantage that no further step in the production process is required for the integration of the identifier.

The plastic film can be produced using any production process such as, for example, an injection moulding process or an extrusion process. The plastic film according to the invention can also be produced, at least partially, through lamination.

In a preferred embodiment, the plastic film is produced through an injection moulding process.

In another preferred embodiment, the plastic film is produced through an extrusion process. Extrusion processes that are suitable for the production of the plastic film include the cast film extrusion process and the blown film extrusion process, wherein the extrusion can also take place through coextrusion, and the cast film extrusion process preferably takes place using flat nozzles. If the plastic film is multi-layered, it can be produced and processed in the form of individual layers, as a composite or as a complete multi-layer film, possibly also in the form of a tubular film. Individual layers and/or one or more composites can preferably be bonded through lamination. In a preferred embodiment, at least part of the plastic film is produced in the form of a cast film (as flat film extrudate). In another preferred embodiment, the entire plastic film is produced in the form of a coextruded cast film. In a further embodiment, the plastic film is produced as a multi-layered blown film through extrusion, preferably through blown film coextrusion.

According to the invention, the machine-detectable identifier is integrated into the plastic film during the production of the plastic film, preferably during the extrusion process or the injection moulding process. In a preferred embodiment, the identifier is introduced into the plastic mass of at least one layer to be extruded. In another preferred embodiment, the identifier is introduced into the plastic mass for the injection moulding process.

According to a preferred embodiment the capsule body is produced, at least partially, preferably completely, from the plastic film. Preferably, the capsule body is produced through a shaping process, more preferably through deep drawing. According to the invention, the machine-detectable identifier is already available during the shaping process. In a preferred embodiment, the identifier is introduced into the plastic mass, preferably into the plastic granulate, from which the, as yet unshaped, plastic film is produced, preferably through (co) extrusion or injection moulding.

According to a further preferred embodiment, the cover is produced, at least partially, preferably completely, from the plastic film. Preferably, the capsule body is produced from the plastic film through a shaping process, for example through being punched out of or cut into the plastic film. According to the invention, the machine-detectable identifier is already available during the shaping process. In a preferred embodiment, the identifier is introduced into the plastic mass, preferably into the plastic granulate, from which the, as yet unshaped, plastic film is produced, preferably through (co)extrusion or injection moulding.

According to another preferred embodiment, the identifier is provided at least in several sections of the plastic film arranged at regular intervals. It is particularly preferred that the identifier extends across the entire surface of the plastic film. This has the advantage that the part of the portion capsule comprising the identifier, preferably the capsule body and/or the cover, can be produced from any section of the plastic film.

The plastic film can be mono-layered or multi-layered. If the plastic film is multi-layered, the identifier can be provided in one or more layers of the plastic film.

In a preferred embodiment of the invention, the plastic film comprises at least a layer (a) with a specified value for electrical resistance, preferably surface resistance and/or contact resistance, as identifier. The layer (a) is preferably available as a surface layer of the plastic film. It is particularly preferred that the layer (a) forms the side of the plastic film facing the cavity.

The layer (a) can be produced from one or more plastics, preferably thermoplastic polymers, and can, if necessary, contain an electrically conductive additive and/or magnetic additive.

In a preferred embodiment of the invention, the layer (a) is based on at least two plastics, preferably thermoplastic polymers, with a different value for electrical resistance, preferably surface resistance and/or contact resistance, in a specified mixing ratio.

Preferably, the layer is based on at least one, more preferably at least two, thermoplastic polymers selected from the group comprising polyolefins, polyamides, polyamidimides, polyesters and copolymers from at least two monomers of the named polymers. Mixtures of at least one polyamide and at least one polyester are particularly preferred.

Suitable thermoplastic polyamides for producing the layer (a) are thermoplastic aliphatic, partially aromatic or aromatic homo- or copolyamides. Such polyamides are polyamides from diamines such as aliphatic diamines with 2-10 carbon atoms, in particular hexamethylene diamine and tetramethylene diamine, or aromatic diamines with 6-10 carbon atoms, in particular p-phenylene diamine, and dicarboxylic acids with 6-14 carbon atoms, such as, for example, adipic acid, terephthalic acid, or isoterephthalic acid. Furthermore, the polyamides can be made from lactams with 4-10 carbon atoms, such as, for example, e-caprolactam. Polyamides that are particularly suitable for the production of the layer (a) are, for example, PA 46, PA 6, PA 66, PA 11, PA 12 and/or mixtures of at least two of these polyamides.

Thermoplastic, aliphatic, partially aromatic or aromatic homo- or copolyesters can be used as polyesters for the production of the layer (a). Such polyesters are derived from polyols, such as ethylene glycol for example, or 1.4 butanediol and dicarboxylic acids or dicarboxylic acid derivates such as adipic acid and/or terephthalic acid. Preferably, polybutylene adipate (PBA), polyethylene terephthalate (PET), polybutylene terephthalate (PBT) or the corresponding co-polymers are suitable

If a thermoplastic polyolefin is used to produce the layer (a), thermoplastic olefin-homo-or copolymers of a,β-unsaturated olefins with 2-10 carbon atoms such as, for example, polyethylene (PE, in particular LDPE or HDPE), polypropylene (PP), polybutylene (PB), polyisobutylene (PI) or mixtures of at least two of the named polymers, can be used. “LDPE” designates low density polyethylene, which has a density in the region of 0.86-0.93 g/cm3 and is characterised by a high degree of molecular branching. “HDPE” designates high density polyethylene, which only has a low degree of molecular branching, with a density lying in the region between 0.94 and 0.97 g/cm3. Preferred polyolefins for the production of the layer (a) are ethylene homo- or copolymers and propylene homo- or copolymers.

Preferably, the plastic film and/or the layer (a) fitted with the identifier is not electrically conductive. This means that the conductivity of the plastic film and/or the layer (a) is too low to close a circuit, for example to close the circuit of a control unit mounted on the beverage vending machine.

Preferably, the specific surface resistance of the plastic film and/or the layer (a) fitted with the identifier is at least 10⁹ Ω/sq, more preferably at least 10¹⁰ Ω/sq, most preferably 10¹¹ Ω/sq, and, in particular 10¹¹ Ω to 10¹⁴ Ω/sq, preferably measured in accordance with DIN 53482.

Preferably, the specific contact resistance (volume resistance) of the plastic film and/or the layer (a) fitted with the identifier is at least 10⁹ Ω cm, more preferably at least 10¹⁰ Ω cm, most preferably 10¹¹ Ω cm and, in particular 10¹¹ Ω to 10¹⁸ Ω cm, preferably measured in accordance with DIN 53482.

The value of the electrical resistance, preferably surface resistance or contact resistance, is preferably determined by one or more polymer components and, in the case of several polymer components, by their mixture ratio and/or by the thickness of the layer (a).

The use of the electrical resistance of such a layer, which is based purely on plastics, as identifier has the advantage that the identifier is based solely on the material properties of the plastic film and, therefore, special additives are not necessary. This has the further advantage that the recyclability of the portion capsule is not impaired and the identifier is preserved and is still legible even if the portion capsule is damaged or deformed. Alternatively or additionally, therefore, the identifier can be used to sort the materials from which the portion capsule is produced during a subsequent disposal and/or recycling process. The use of a polyamide as polymer components of the layer (a) can also increase the stiffness of the plastic film.

The identifier can be, for example, an optically recognisable material, for example a fluorescent and/or phosphorescent substance, which is integrated into the film or one of its layers.

A fluorescent substance for the purpose of the invention consists of at least one molecule, with at least one electron which, excited by electromagnetic radiation, is preferably released from its orbit and raised into a preferably empty, vacant orbit containing more energy. This excited state is generally unstable, which means that the electron falls back into its original orbit and its energy is released, at least partially, in the form of electromagnetic radiation. This released electromagnetic radiation preferably has a longer wave length than the exciting electromagnetic radiation. In the case of an identifier which is based on a fluorescent substance, a sensor receives the released radiation and a connected control unit compares the profile and/or the intensity of the radiation with a stored profile. If these profiles are at least partially identical, the connected control unit knows that the capsule is a portion capsule and not a cleaning capsule and releases the vending machine. Alternatively or additionally, the control unit recognises what type of portion capsule it is, for example, tea, coffee, milk or such like, and controls the vending machine accordingly. Preferably, the released radiation comprises at least one, more preferably several, maxima. The sensor and/or the connected control unit then investigate whether there is at least one of these maxima in the received radiation.

A phosphorescent substance for the purpose of the invention consists of at least one molecule, with at least one electron which, excited by electromagnetic radiation, is preferably released from its orbit and raised into a preferably empty, vacant orbit containing more energy. This excited state is generally unstable, which means that the electron falls back into its original orbit and its energy is released, at least partially, in the form of electromagnetic radiation. This released electromagnetic radiation preferably has a longer wave length than the exciting electromagnetic radiation. In the case of a phosphorescent substance, however, the emission of radiation does not end with the end of the radiation but decays over a longer period than in the case of fluorescence. In the case of an identifier which is based on a phosphorescent substance, a sensor, which is provided in or on the vending machine, receives the released radiation and a connected control unit compares this decay profile with a stored decay profile or profile section. Preferably, the intensity of this radiation, in particular at a specific frequency, is compared with a stored decay profile and/or a specific value. If these profiles are at least partially identical, the connected control unit knows that the capsule is a portion capsule and not a cleaning capsule and releases the vending machine. Alternatively or additionally, the control unit recognises what type of portion capsule it is, for example, tea, coffee, milk or such like, and controls the vending machine accordingly. The sensor and/or the connected control unit investigate how much time has passed since the original intensity of the radiation has decayed by a specific percentage rate and compares the measured value with a stored value. Alternatively or additionally, the sensor and/or the connected control unit investigate how high the intensity of the radiation is after a specific length of time, in particular at a specific frequency, and this value is compared with a stored value. If the stored value is the same as the measured value, the control unit releases the vending machine or selects a specific preparation program for the particular beverage or food. If the stored value is not the same as the measured value, the vending machine can only be put into operation under specific conditions, as the capsule could be a cleaning capsule.

The fluorescent and/or phosphorescent substance is illuminated with a specific electromagnetic radiation and during and/or after the radiation has been switched off, the fluorescence and/or phosphorescence is measured. The radiation can take place with one or more wavelengths. The radiation can comprise one or more sources, which are used simultaneously or successively.

One or more sensors can analyse the radiation emitted by the fluorescent and/or phosphorescent substance. The sensor is preferably provided in the vending machine, for example its brewing chamber or in the area of the insertion slot.

Alternatively or additionally, the layer (a) can comprise at least one internal antistatic agent. Such antistatic agents, which can be integrated as additives in the plastic mass to improve electrical conductivity, are generally known from prior art. Quarterny ammonium compounds, alkylsulfonates, alkylsulfates, alkylarylsulfonates, dithiocarbamates, polyglycols, ethoxylated fatty amines, ethoxylated fatty amides, ethoxylated fatty alcohols, ethoxylated alkyl phenols, polyethylene glycol fatty acid esters, glycerine and sorbitan partial esters as well as carbon-based antistatic agents, such as carbon nanotubes or soots for example, are suitable as antistatic agents. If an antistatic agent is contained in the layer (a), the weight of the antistatic agent is preferably 0.01 up to 20 wt %, more preferably 0.1 up to 10 wt %, based on the total weight of the layer (a). In this embodiment, the value of the surface resistance is preferably determined by the antistatic agent, the one or more polymer components, and/or the thickness of the layer (a). The antistatic agent, distributed in the plastic film, is preferably present across the entire surface of the layer (a). The antistatic agent is preferably added to the granulate of the plastic components before the particular layer is produced, preferably through extrusion.

The electrical resistance, preferably surface resistance and/or contact resistance, of the layer (a) is preferably measured across two contact points by means of a sensor, an ohmmeter for example, mounted on the beverage vending machine. The contact points can be located on the cover and/or the capsule body. Preferably, the measurement is carried out across two contact points on the capsule body. If the measured value does not correspond to the reference value, the putting into operation of the beverage vending machine is preferably blocked. Additionally, an optical and/or acoustic warning signal is preferably set off. In this way, for example, a portion capsule that is produced from an inappropriate plastic material can be prevented from being used in the particular beverage vending machine and being subjected to too high a temperature or too high pressure.

Alternatively or additionally, the contact resistance of the plastic film and/or the layer (a) fitted with the identifier can be affected by the thickness of the plastic film and/or the layer (a).

In a preferred embodiment of the invention, the identifier can be detected by means of a magnetic sensor. In this embodiment, there is preferably a magnetic, preferably ferromagnetic or ferromagnetic, additive in at least one layer of the plastic film. Suitable magnetic additives are, for example, iron, cobalt and their alloys, including AINiCo, SmCo, CoFe, AINiCoCu, CuNiCo, CoFe, CoFeV, FeMo, FeMoCo, CuNiFe, FePt, CoPt, CeCo and NdFeB, chromium dioxide, iron oxides, such as magnetite and hematite for example, and magnetic ferrites, in particular calcium, strontium and barium hexaferrit, and their mixtures.

The magnetic additive can be present in one or more layers of the plastic film. Preferably the magnetic additive is dispersed in the material of the particular layer(s). In a preferred embodiment, the optically detectable additive is present in at least one internal layer. In another preferred embodiment, the magnetic additive is present in at least one surface layer of the plastic film, preferably in the side of the plastic film facing the cavity of the portion capsule. The magnetic additive is preferably distributed over the entire surface of the plastic film. The magnetic additive is preferably added to the granulate of the plastic components before the particular layer is produced, preferably through extrusion.

A sensor mounted on the beverage vending machine preferably detects the magnetic flux density. If the measured value does not correspond to the reference value, the putting into operation of the beverage vending machine is preferably blocked. Additionally, an optical and/or acoustic warning signal is preferably set off. In this way, for example, a portion capsule that is produced from an inappropriate plastic material can be prevented from being used in the particular beverage vending machine and being subjected to too high a temperature or too high pressure.

In a further preferred embodiment of the invention, the identifier is optically detectable. The plastic film preferably comprises at least one optically detectable additive as identifier. The optically detectable additive can be present in one or more layers of the plastic film. In a preferred embodiment, the optically detectable additive is present in at least one internal layer. In another preferred embodiment, the optically detectable additive is present in at least one surface layer of the plastic film, preferably in the side of the plastic film facing the cavity of the portion capsule.

The optically recognisable additive is preferably distributed over the entire surface of the plastic film. The optically recognisable additive is preferably added to the granulate of the plastic components before the particular layer is produced, preferably through extrusion.

In a preferred embodiment of the invention, the optically recognisable additive is contained in the plastic film in a quantity of 0.001 to 15 wt %, more preferably of 0.01 to 10 wt %, based on the total weight of the plastic film. In another preferred embodiment, the optically recognisable additive is contained in at least one layer, preferably in a surface layer of the plastic film in a quantity of 0.001 to 15 wt %, more preferably of 0.01 to 10 wt %, based on the total weight of the particular layer.

In a preferred embodiment, a luminescent and/or phosphorescent compound is available as an optically recognisable additive.

For the purpose of the invention “luminescent” refers to a compound which, upon excitation by energy input—such as by absorption of UV radiation—is capable of emitting electromagnetic radiation, which arises in the transition from an electronically excited state to a lower energy state e.g. in the basic state, the emitted electromagnetic radiation usually being lower in energy than that previously absorbed. The emitted electromagnetic radiation can have a wavelength in the wavelength range of UV radiation, preferably in a wavelength range of 200 to 380 nm, in the wavelength range of visible light, preferably in a wavelength range of 380 to 780 nm, more preferably in a wavelength range of 400 to 500 nm, and/or in the wavelength range of infrared radiation, preferably in a wavelength range of >780 nm, more preferably from 780 nm to 1 mm. Two manifestations of luminescence can be distinguished, namely fluorescence and phosphorescence. Specialists are familiar with these terms. Fluorescent compounds are particularly preferred.

Suitable luminescent and/or phosphorescent compounds are preferably inorganic or organic compounds, more preferably selected from the group consisting of inorganic colorants, inorganic pigments, organic colorants and organic pigments, which can luminesce, preferably fluoresce or phosphoresce, more preferably fluoresce.

Preferably suitable as a luminescent and/or phosphorescent compound used in the invention is at least one compound, which luminesces when excited by UV radiation, preferably when excited by UV radiation in a wavelength range of 200 to 400 nm. Preferably suitable as a luminescent and/or phosphorescent compound used in the invention is at least one compound which, when excited by UV radiation, emits light in the wavelength range of the visible and/or infrared electromagnetic radiation, more preferably light in the wavelength range of the visible electromagnetic radiation, most preferably in a wavelength range of 400 to 500 nm.

The luminescent and/or phosphorescent compound can, for example, be detected by machine by determining the wavelength of its radiation emitted upon excitation by energy supply and/or by means of the energy input and/or the temperature at which this event occurs. Any conventional luminescence scanner is preferably suitable as a means of detection. Such means of detection preferably comprises a transmitter for the transmission of radiation, preferably in the UV range, by means of which the luminescent and/or phosphorescent compound is excited, and, further, a device for the reception and evaluation of the radiation emitted by the luminescent and/or phosphorescent compound.

In a further preferred embodiment, an additive which irreversibly changes its optical properties upon being supplied with energy, for example through absorption of UV radiation or through an increase in temperature, is available as an optically detectable additive. Preferably, this additive is a laser light-absorbing additive, which is preferably distributed, more preferably dispersed, over the entire surface of the plastic film. Through the action of laser light on this additive, the plastic film can be equipped with an optically detectable identifier, preferably a barcode, logo or report; i.e. the plastic film can be described through the action of a laser.

Suitable laser light-absorbing additives are known from EP 1 567 594 and EP 1 567 595, for example. They preferably contain at least one metallic salt as a laser light-absorption medium and/or laser light-reflector, at least one carbonising polymer, and at least one modified polyolefin homo- or copolymer. Suitable metallic salts are, for example, oxides, hydroxides, sulphides, sulphates and phosphates of copper, bismuth, tin, silver, titanium, antimony, manganese, iron, nickel and chromium, as well as laser light-absorbing inorganic and organic colorants, in particular azo colorants. Modified propylene homo- or copolymers, which are modified with at least one organic acid or at least one organic acid anhydride, preferably with maleic acid anhydride, are particularly suitable as modified polyolefin homo- or copolymers.

In a preferred embodiment, an optically detectable identifier acted upon by such a laser-light absorbing additive, preferably in the form of a barcode, logo or report, is present in the plastic film. Preferably, the plastic film is provided with the laser-light absorbing additive during its production. The action of the laser light can take place either prior to the production of the portion capsule or subsequently.

In a further preferred embodiment of the invention, the identifier is a machine-detectable surface structure. Particularly preferred are identifier stripes. If the plastic film is produced by (co)-extrusion, the machine-detectable surface structure is introduced into plastic film during the extrusion of the plastic film by means of a shaping calender roll. In this case, identifier stripes are particularly preferred. Alternatively, if the plastic film is produced by injection moulding, it is provided with the machine-detectable surface structure preferably by means of a correspondingly shaped cavity of the injection mould or stamp. The machine-detectable surface structure can have any shape. Patterns, grains, engravings and, in particular, identifier stripes are suitable.

With the portion capsule according to the invention, it is possible to prevent portion capsules that are not intended for particular beverage vending machines from being inserted into them. The identifier also makes it possible for a beverage vending machine to recognise what type of capsule is in its brewing chamber and to adjust the beverage or food production process, i.e. the quantity of water, the necessary extraction pressure and/or the desired temperature, accordingly.

A further object of the present invention is the use of a portion capsule according to the invention to produce a beverage, preferably to produce a coffee, cocoa, tea and/or milk drink or food, in particular a soup.

The statements made in relation to an object of the present invention apply to the other objects equally and vice versa.

### BRIEF DESCRIPTION OF DRAWINGS

Embodiments of the invention are illustrated in the figures and explained in detail in the following description. The figures are merely described by way of example and do not limit the general inventive idea. The description applies equally to all objects of the present invention.

FIG. 1 shows a portion capsule the capsule body of which is produced from a plastic film with a specified value for the surface resistance.

FIG. 2 shows a portion capsule the cover of which is produced from a plastic film with a specified value for the surface resistance.

FIG. 3 shows a portion capsule the capsule body of which is produced from a plastic film, wherein a luminescent and/or phosphorescent compound is dispersed in the surface layer (a) of the plastic film.

FIG. 4 shows a portion capsule the capsule body of which is produced from a plastic film, wherein a laser-light absorbing additive is dispersed in the surface layer of the plastic film, and which comprises a barcode generated through the action of laser light.

FIG. 5 shows a portion capsule the cover of which is produced from a plastic film with tactically detectable identifier stripes.

### DETAILED DESCRIPTION

FIG. 1 shows a portion capsule 1 which comprises a capsule body 2 with a wall 2.1 and a capsule base 2.2 as well as a cover 3. The wall and the capsule base define a cavity 4, in which a beverage substrate and an installation element, if appropriate, are provided. This cavity, once it has been filled, is sealed by the cover, which is preferably attached to the edge 2.3 of the capsule body, for example through sealing or gluing. This coffee capsule is introduced into a brewing chamber 8, in which a liquid, water for example, flows through it. The beverage substrate is extracted or released, thereby producing the desired beverage. According to the invention, this portion capsule comprises an identifier 5, which makes it possible to determine whether the particular portion capsule is suitable for the production of a beverage or a food. If this is not the case, significant health problems may arise. For example, the use of a cleaning capsule can lead to the production of an aqueous solution which is unpalatable for the user. This should be avoided. According to the invention, this identifier is provided in a mono-layer or multi-layer plastic film 6, from which the portion capsule is, at least partially, produced. In the present case, the capsule body is produced from a plastic material which has three layers. The outer-facing surface layer 7 of the plastic material in the capsule body is, in this particular case, constructed from a polyamide and a polyester, which are in a specific mixing ratio. The surface resistance of the surface layer 7 acts as an identifier. This can be measured across two contact points 9 by means of an ohmmeter mounted on the beverage vending machine. If the measured value does not correspond to the reference value, the putting into operation of the beverage vending machine is blocked. Additionally, an optical and/or acoustic warning signal is set off. In this way, a portion capsule that is not suitable for the beverage vending machine can be prevented from being used in the particular beverage vending machine and being subjected to too high a temperature or too high pressure. The identifier is based in this case solely on the material properties of the plastic film, in particular the type of the polyamide and polyester used, their mixing ratio and the thickness of the surface layer 7.

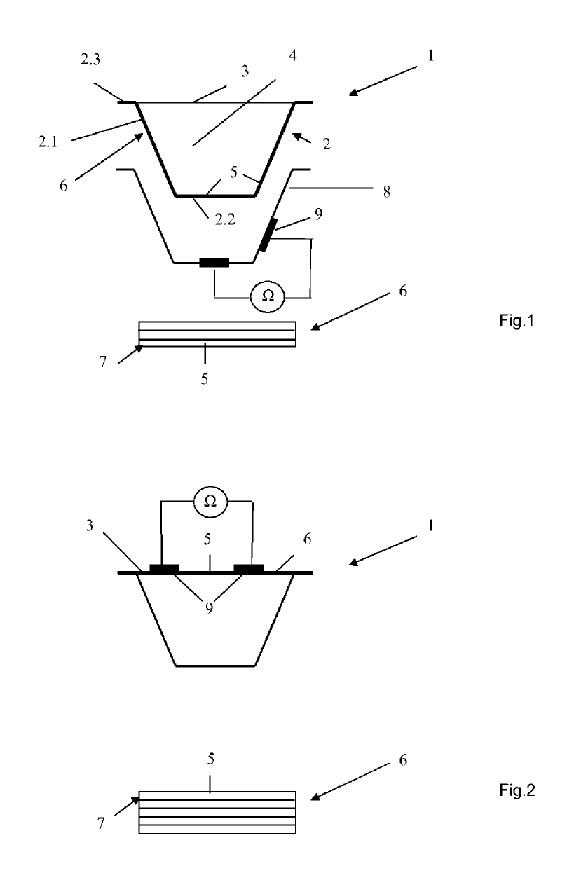

FIG. 2 shows a further embodiment of the portion capsule according to the invention. In this particular case, the cover is produced from the plastic film which, in this case, has five layers. In this particular case, the surface layer of the plastic film comprises an antistatic agent. The surface resistance of the surface layer 7 acts as an identifier. This can be measured across two contact points 9 by means of an ohmmeter mounted on the beverage vending machine. If the measured value does not correspond to the reference value, the putting into operation of the beverage vending machine is blocked. The surface resistance can be specified through the choice of antistatic agent, its quantity, as well as through the choice of plastic components and the thickness of the surface layer.

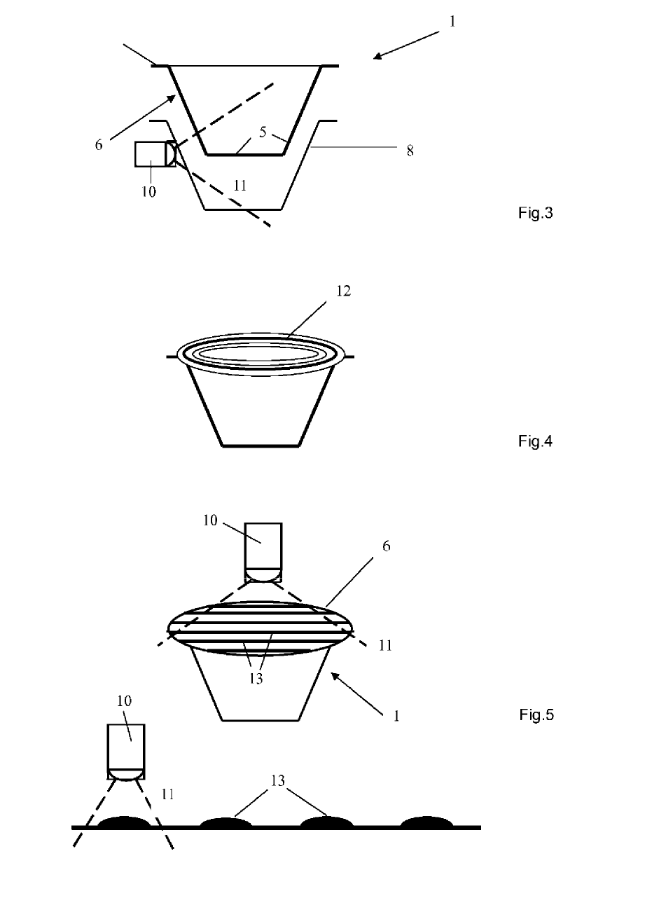

FIG. 3 shows a further embodiment of the portion capsule according to the invention. In this particular case, the capsule body is produced from the plastic film, in the surface layer of which a luminescent and/or phosphorescent compound is dispersed. The luminescent and/or phosphorescent compound can be detected by means of a detection medium and/or a sensor 10 by determining the wavelength of its radiation emitted upon excitation by energy supply. The detection medium comprises a transmitter for the transmission of UV radiation, for example, by means of which the luminescent and/or phosphorescent compound is excited. Further, the detection medium comprises a device for the reception and evaluation of the radiation emitted by the luminescent and/or phosphorescent compound. If the measured value does not correspond to the reference value, the putting into operation of the beverage vending machine is blocked.

FIG. 4 shows a further embodiment of the portion capsule according to the invention. In this particular case, the cover is produced from a plastic film, in the surface layer of which a laser light-absorbing additive is dispersed, and which comprises a barcode 12 produced by the action of the laser light. The barcode 12 can be read with the aid of a detection medium and/or sensor.

FIG. 5 shows a further embodiment of the portion capsule according to the invention. In this particular case, the cover is produced from a plastic film which comprises a machine detectable surface structure 13 as identifier. The identifier can be read with the aid of a detection medium and/or sensor.

### LIST OF REFERENCES

1 Portion capsule
2 Capsule body
2.1 Wall
2.2 Capsule base
2.3 Edge, flange
3 Cover, cover film
4 Cavity
5 Identifier
6 Plastic film
7 Surface layer
8 Brewing chamber
9 Contact points
10 Means of detection/sensor
11 Ray
12 Barcode
13 Surface structure/identifier stripes

1. Portion capsule for producing a beverage, comprising a capsule body with a capsule base and a cover wherein, between the capsule base and the cover, a cavity is formed in which a beverage substrate is provided, and which comprises a machine-detectable identifier, which enables the respective portion capsule to be individualised, wherein the identifier is provided in a mono-layer or multi-layer plastic film, from which the portion capsule is, and comprises a machine-detectable detectable surface structure and wherein the identifier is optically detectable.

2. Portion capsule according to claim 1, characterised in that the capsule body is, at least partially, produced from the plastic film.

3. Portion capsule according to claim 1, characterised in that the cover is, at least partially, produced from the plastic film.

4. Portion capsule according to claim 1, characterised in that the plastic film comprises a laser light-absorbing additive.

5. Portion capsule according to claim 1, characterised in that the optically detectable identifier is present in the form of a barcode, logo or report.

6. Use of a portion capsule according to claim 1 for the production of a beverage, preferably for the production of a coffee, cocoa, tea and/or milk drink.
